(19) United States
(12) Patent Application Publication
(10) Pub. No.: US 2010/0077204 A1
(43) Pub. Date: Mar. 25, 2010

(54) INFORMATION PROCESSING APPARATUS, MANAGEMENT APPARATUS, COMMUNICATION SYSTEM AND COMPUTER READABLE MEDIUM

(75) Inventor: Kenji KAWANO, Tokyo (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/389,059

(22) Filed: Feb. 19, 2009

(30) Foreign Application Priority Data
Sep. 25, 2008 (JP) 2008-246851

(51) Int. Cl. H04L 9/00

(52) U.S. Cl. 713/153; 380/278

(57) ABSTRACT

An information processing apparatus connected to a management apparatus via a communication line, includes: an other-apparatuses information acquisition unit that acquires information concerning a plurality of other information processing apparatuses from the management apparatus; a key registration unit that registers first keys to be used in encrypted communication between the information processing apparatus and each of the plurality of other information processing apparatuses, into a storage unit; a key transmitting unit that collectively transmits the first keys to the management apparatus; and a key acquisition unit that acquires from the management apparatus second keys that each has been transmitted to the management apparatus from the respective one of plurality of other information processing apparatuses. The key registration unit further registers the second keys acquired by the key acquisition unit into the storage unit.

### CROSS-REFERENCE TO RELATED APPLICATIONS

This application is based on and claims priority under 35 USC 119 from Japanese Patent Application No. 2008-246851 filed Sep. 25, 2008.

### BACKGROUND

1. Technical Field

The present invention relates to an information processing apparatus, a management apparatus, a communication system and a computer readable medium.

2. Related Art

As a security technique for ensuring safety in information communication using unit such as the Internet, for example, SSL (Secure Socket Layer) is known in which authentication of devices and encryption of data are performed. In the SSL, authentication of servers, authentication of clients, and encryption of communication sessions are performed so that spoofing and information leakage are prevented in communication between a client and a server. Further, for example, as a security protocol in the IP (Internet Protocol) layer, IPsec (Security Architecture for Internet Protocol) is known that has been set forth by IETF (Internet Engineering Task Force) which is a standardization organization for Internet techniques.

The SSL and the IPsec are used as encryption protocols in Internet VPN (Virtual Private Network) which is a technique for constructing a virtual private network via the Internet.

When encrypted communication is to be performed by using an encryption protocol such as the SSL and the IPsec, before the starting of communication, a session key to be used in the encrypted communication need be shared between the communication counterparts. The sharing of a session key is achieved, for example, by transferring a session key generated by any one of the transmitting side apparatus and the receiving side apparatus of the communication, to the other side.

In the SSL, at the time of establishing a communication session, server authentication, client authentication, and encryption key exchange are performed. As the method of encryption key exchange, for example, an algorithm such as RSA (Rivest Shamir Adleman) key exchange and Diffie-Hellman key exchange is used. Such authentication processing performed at the time of session establishment causes a higher processing load than that caused by data encryption processing performed after the encryption key exchange. Thus, in general, after a session is established once, a session ID (identifier) is shared between the server and the client so that encrypted communication is performed by using the session key of the session ID during the term of validity of the session ID.

In the IPsec, before the starting of communication of encrypted data, determination of a cryptosystem and exchange of an encryption key to be used in the communication are performed by using an IKE (Internet Key Exchange) protocol so that a connection referred to as an SA (Security Association) is established.

### SUMMARY

According to an aspect of the invention, an information processing apparatus connected to a management apparatus via a communication line, includes: an other-apparatuses information acquisition unit that acquires information concerning a plurality of other information processing apparatuses connected to a management apparatus, from the management apparatus connected via the communication line; a key registration unit that registers first keys to be used in encrypted communication between the information processing apparatus and each of the plurality of other information processing apparatuses, into a storage unit, where each of the first keys is associated with a respective one of the plurality of other information processing apparatuses; a key transmitting unit that collectively transmits the first keys to the management apparatus; and a key acquisition unit that acquires from the management apparatus second keys that each corresponds to the information processing apparatus and that each has been transmitted to the management apparatus, from the respective one of plurality of other information processing apparatuses. The key registration unit further registers the second keys acquired by the key acquisition unit into the storage unit. Each of the second keys is associated with the respective one of the plurality of other information processing apparatuses.

### BRIEF DESCRIPTION OF THE DRAWINGS

Exemplary embodiment(s) of the present invention will be described in detail based on the following figures, wherein:

FIG. 1 is a diagram showing an example of a schematic configuration of a VPN system;

FIG. 2 is a block diagram showing an example of a schematic internal configuration of a VPN terminal;

FIG. 3A is a diagram showing an example of data contents in a key DB;

FIG. 3B is a diagram showing an example of data contents in a key DB;

FIG. 4 is a block diagram showing an example of a schematic internal configuration of a VPN-DNS server;

FIG. 5 is a diagram showing an example of data contents in a terminal information DB;

FIG. 6 is a diagram showing an example of contents of a key table;

FIG. 7 is a diagram showing an example of a procedure of processing performed by a VPN system;

FIG. 8 is a diagram showing an example of a procedure of terminal information registration processing;

FIG. 9 is a diagram showing an example of a procedure of key registration processing;

FIG. 10 is a diagram showing an example of a procedure of key acquisition processing;

FIG. 11 is a flow chart showing an example of procedure of processing performed by communication processing unit of a VPN terminal at the time of data transmission;

FIG. 12A is a diagram showing an example of a configuration of a data packet transmitted by a VPN terminal;

FIG. 12B is a diagram showing an example of a configuration of a data packet transmitted by a VPN terminal;

FIG. 13 is a flow chart showing an example of procedure of processing performed by communication processing unit of a VPN terminal at the time of data receiving;

FIG. 14 is a diagram showing another example of a schematic configuration of a VPN system;

FIG. 15 is a diagram showing another example of data contents in a terminal information DB;

FIG. 16 is a diagram showing another example of a configuration of a data packet transmitted by a VPN terminal;

FIG. 17 is a diagram showing another example of data contents in a key DB;

FIG. 18 is a diagram showing another example of a configuration of a data packet transmitted by a VPN terminal;

FIG. 19 is a diagram showing another example of a schematic configuration of a VPN system; and

FIG. 20 is a diagram showing an example of a hardware configuration of a computer.

### DETAILED DESCRIPTION

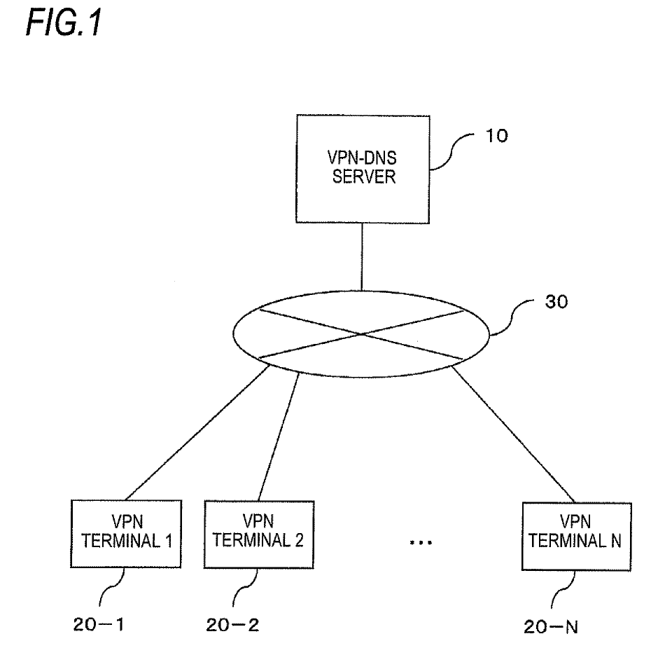

FIG. 1 is a diagram showing an exemplary configuration of a VPN system. The VPN system is constructed from a VPN-DNS (Domain Name System) server 10 and VPN terminals 20-1, 20-2, . . . , 20-N (generically referred to as the “VPN terminal 20”, herein after) that are connected to each other through a network 30 such as the Internet. Each VPN terminal 20 performs encrypted communication with each of other VPN terminals 20 through the network 30. The VPN-DNS server 10 is a server for managing the VPN terminals 20, and mediates the exchange of common keys in the encrypted communication between the individual VPN terminals 20.

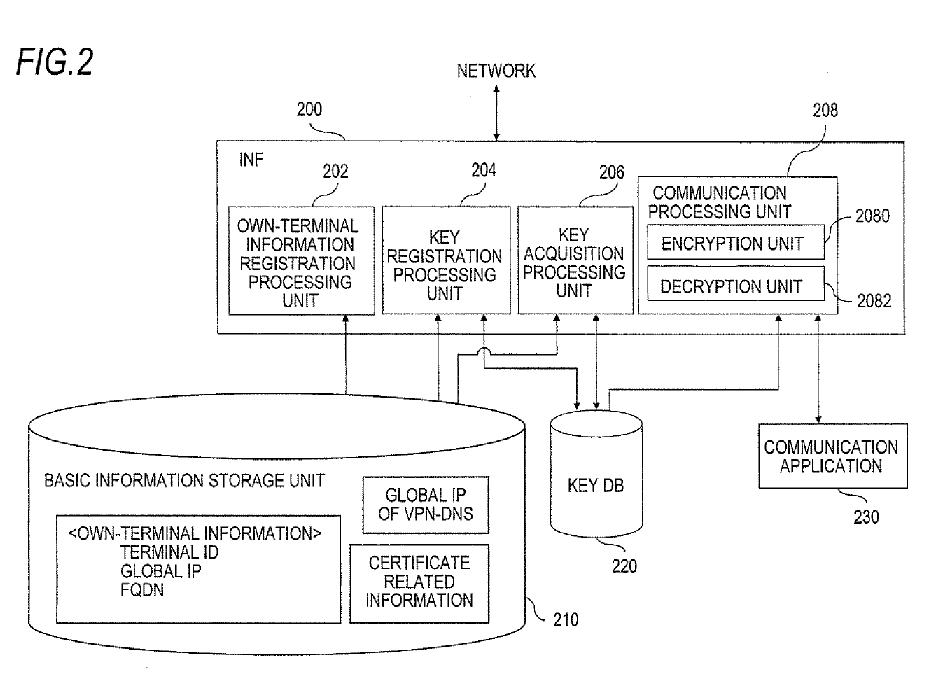

FIG. 2 shows an example of a schematic internal configuration of the VPN terminal 20. With reference to FIG. 2, the VPN terminal 20 has an NIF (network interface) 200, basic information storage unit 210, a key DB (database) 220, and communication application 230.

The NIF 200 is an interface for communication with other apparatuses through the network 30. The NIF 200 has own-terminal information registration processing unit 202, key registration processing unit 204, key acquisition processing unit 206, and communication processing unit 208.

The own-terminal information registration processing unit 202 performs the processing of registering, into the VPN-DNS server 10, own-terminal information which is information relating to each VPN terminal 20 itself. The own-terminal information includes, for example, the terminal ID (identifier) of the VPN terminal 20, the global IP of the VPN terminal 20 (an IP address unique in the network 30), and the FQDN (Fully Qualified Domain Name) of the VPN terminal 20. The own-terminal information registration processing unit 202 acquires own-terminal information from the basic information storage unit 210, and then transmits the information to the VPN-DNS server 10.

The key registration processing unit 204 performs the processing of registering into the VPN-DNS server 10 a session key assigned by the VPN terminal 20 to each of other VPN terminals 20. The key registration processing unit 204 acquires from the VPN-DNS server 10 a list of the terminal information of each of other VPN terminals 20 registered in the VPN-DNS server 10, and then assigns a session key to each VPN terminal 20 in the acquired list. Then, the key registration processing unit 204 transmits the terminal ID of each VPN terminal 20 and the session key assigned to each VPN terminal 20, to the VPN-DNS server 10 in a correspondence manner to each other. The key registration processing unit 204 further registers into the key DB 220 the set of the terminal ID of each of other VPN terminals 20 and the assigned session key. The session key assigned by the key registration processing unit 204 to each of other VPN terminals 20 is used in encryption of data to be transmitted from the own terminal to each of other VPN terminals 20.

The key acquisition processing unit 206 performs the processing of acquiring from the VPN-DNS server 10 the session key having been assigned to the own terminal and registered into the VPN-DNS server 10 by each of other VPN terminals 20. For example, the key acquisition processing unit 206 acquires from the VPN-DNS server 10 the set of the terminal ID of each of other VPN terminals 20 and the session key having been assigned to the own terminal by the VPN terminal 20, and then registers the data into the key DB 220. The session key acquired by the key acquisition processing unit 206 is used in decryption of data received by the own terminal from the corresponding VPN terminal 20.

The communication processing unit 203 performs processing concerning encrypted communication with each of other VPN terminals 20. The communication processing unit 208 has encryption unit 2080 and the decryption unit 2082. When data is to be transmitted from the VPN terminal 20 to each of other VPN terminals 20, the encryption unit 2080 acquires from the key DB 220 the session key assigned by the key registration processing unit 204 to the VPN terminal 20 of transmission destination, and then encrypts transmission data by using the acquired session key. When encrypted data is received from another VPN terminal 20, the decryption unit 2082 acquires from the key DB 220 the session key assigned by the VPN terminal 20 of transmission source to the own terminal, and then decrypts the received data by using the acquired session key.

The basic information storage unit 210 stores information relating to the VPN terminal 20 and information concerning the VPN-DNS server 10. For example, the basic information storage unit 210 stores the above-mentioned own-terminal information, certificate related information, and the global IP of the VPN-DNS server 10 described above. The certificate related information is information concerning a certificate issued to the VPN terminal 20 by a certificate authority, for example, in the framework of public key cryptosystem (Public Key Infra structure, PKI). The certificate related information includes, for example, a terminal certificate issued to the VPN terminal by the certificate authority, a secret key corresponding to the terminal certificate, and a certificate of the certificate authority having issued the terminal certificate. Here, an ID unique within the system is imparted to the terminal certificate. Thus, the ID of the terminal certificate may be used as the above-mentioned terminal ID.

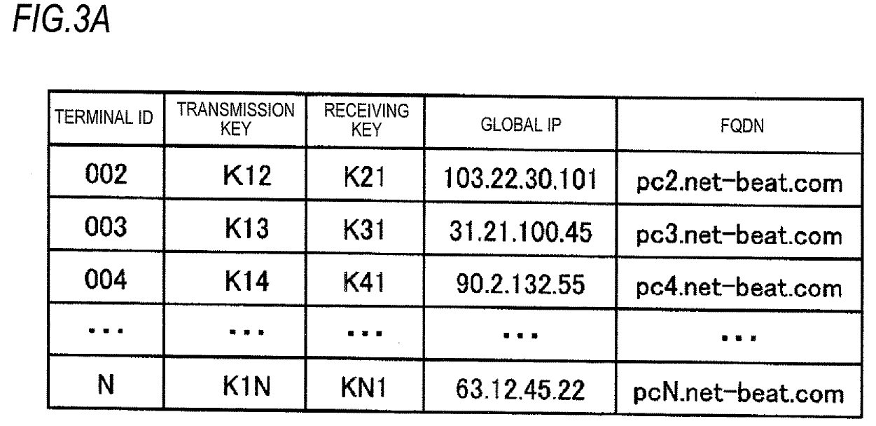

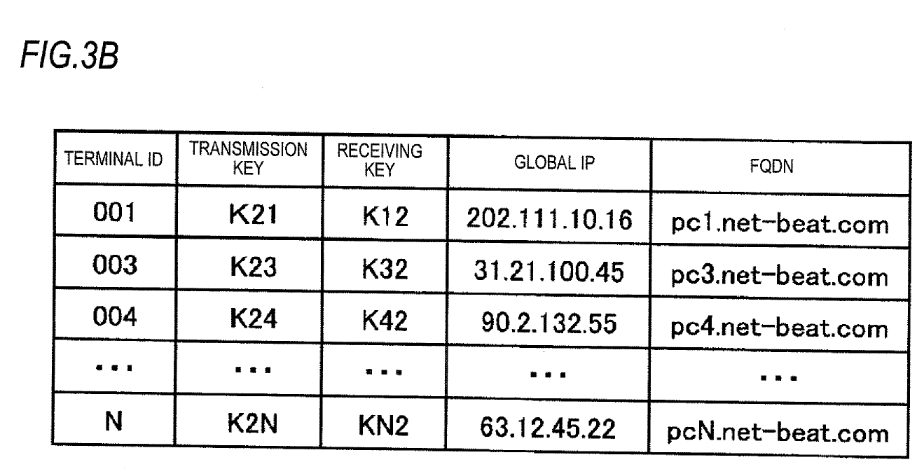

The key DB 220 is a database for storing the session key to be used in encrypted communication with each of other VPN terminals 20. FIGS. 3A and 3B show examples of data contents in the key DB 220. FIG. 3A shows an example of data contents in the key DB 220 of the VPN terminal 20-1, while FIG. 3B shows an example of data contents in the key DB 220 of the VPN terminal 20-2. Each row in each table shown in FIGS. 3A and 3B indicates a record corresponding to one VPN terminal 20. Each record contains the items of terminal ID, transmission key, receiving key, global IP, and FQDN. With reference to FIG. 3A, the key DB 220 of the VPN terminal 20-1 has records each corresponding to each of other VPN terminals 20-2, 20-3, . . . , and 20-N. Further, With reference to FIG. 3B, the key DB 220 of the VPN terminal 20-2 has records each corresponding to each of other VPN terminals 20-1, 20-3, . . . , and 20-N. When the key registration processing unit 204 acquires from the VPN-DNS server 10 a list of the terminal information of each of other VPN terminals 20, the key registration processing unit 204 generates in the key DB 220 a record corresponding to each VPN terminal 20 in the acquired list. The values of the items of terminal ID, global IP, and FQDN in each record are set equal to the values contained in the acquired list of the terminal information. As the item of transmission key, a session key is registered that has been assigned to each of other VPN terminals 20 by the key registration processing unit 204 of the own terminal. Then, by using the session key registered as a transmission key, data to be transmitted to the corresponding VPN terminal 20 is encrypted. Further, as the item of receiving key, a session key is registered that has been assigned to the own terminal by each of other VPN terminals 20. The session key registered as a receiving key is acquired from the VPN-DNS server 10 by the key acquisition processing unit 206 and then registered into each corresponding record in the key DB 220. Then, by using the session key registered as a receiving key, encrypted data received from the corresponding VPN terminal 20 is decrypted.

With reference to FIG. 2 again, the communication application 230 is software used for communication with an apparatus connected to the VPN terminal 20 through the network 30. The communication application 230 realizes transmission and reception of data to and from another apparatus via the NIF 200. For example, the communication application 230 generates data to be transmitted from the VPN terminal 20 to another VPN terminal 20, and transfers the data to the NIF 200. By using the encryption unit 2080, the communication processing unit 208 of the NIF 200 encrypts the data received from the communication application 230, and then sends the data to the network 30. Further, for example, the communication application 230 receives, from the communication processing unit 208, data that has been received from another VPN terminal 20 by the NIP 200 and then decrypted by the decryption unit 2082 of the communication processing unit 208.

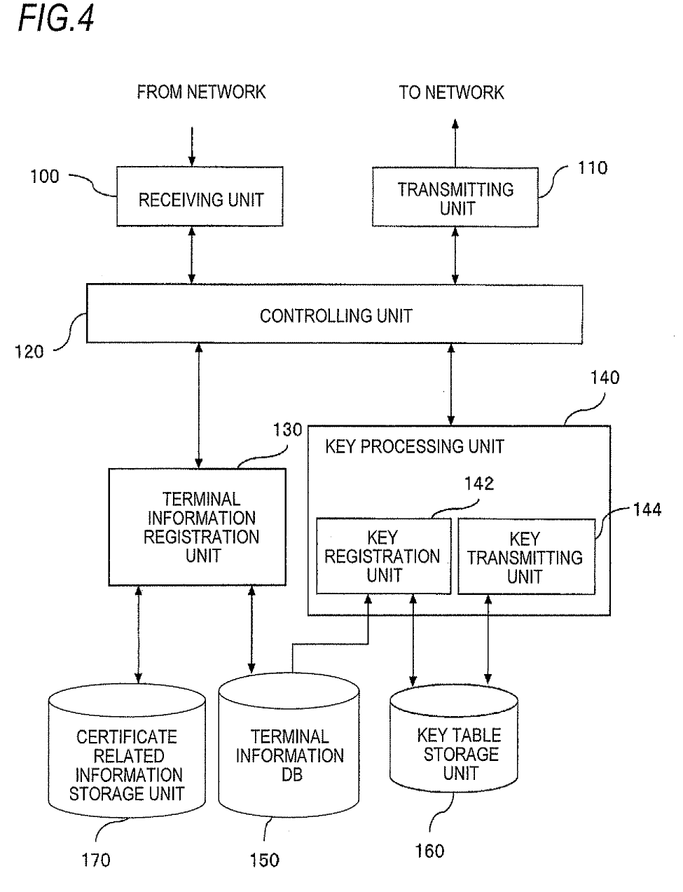

Next, the VPN-DNS server 10 is described below with reference to FIG. 4. FIG. 4 is a block diagram showing an example of a schematic internal configuration of the VPN-DNS server 10. With reference to FIG. 4, the VPN-DNS server 10 has receiving unit 100, transmitting unit 110, controlling unit 120, terminal information registration unit 130, key processing unit 140, a terminal information DB 150, key table storage unit 160, and certificate related information storage unit 170.

The receiving unit 100 receives data transmitted from an apparatus such as a VPN terminal 20 to the VPN-DNS server 10 through the network 30. The receiving unit 100 transfers the received data to the controlling unit 120.

In accordance with an instruction from the controlling unit 120, the transmitting unit 110 transmits data to an apparatus such as a VPN terminal 20 through the network 30.

The controlling unit 120 controls processing in each unit provided in the VPN-DNS server 10. For example, the controlling unit 120 receives from the receiving unit 100 the data received by the receiving unit 100. Then, in accordance with the contents of the received data, the controlling unit 120 controls and causes the terminal information registration unit 130 and the key processing unit 140 to execute processing, then acquires the data of processing result, and then transmits the data through the transmitting unit 110.

The terminal information registration unit 130 performs the processing of registering, into the terminal information DB 150, terminal information sent through the network 30 from each VPN terminal 20.

The terminal information DB 150 is a database for storing information concerning each VPN terminal 20. FIG. 5 shows an example of data contents in the terminal information DB 150. Each row in the table in the example shown in FIG. 5 is a record corresponding to one VPN terminal. Each record in the example shown in FIG. 5 contains items of terminal ID, terminal certificate, global IP, and FQDN.

Description is returned to FIG. 4. The key processing unit 140 performs the processing concerning the session keys to be used in encrypted communication between individual VPN terminals 20. The key processing unit 140 has key registration unit 142 and key transmitting unit 144. The key registration unit 142 acquires, via the receiving unit 100 and the controlling unit 120, session keys assigned by each VPN terminal 20 to other VPN terminals 20, and then registers the acquired session keys into the key table storage unit 160. Then, in response to a key acquisition request from each VPN terminal 20, the key transmitting unit 144 acquires from the key table storage unit 160 a list of session keys assigned to the VPN terminal 20 of requesting source by other VPN terminals 20, and then transfers the acquired list of session keys to the controlling unit 120 so as to transmit the list to the VPN terminal 20 of requesting source.

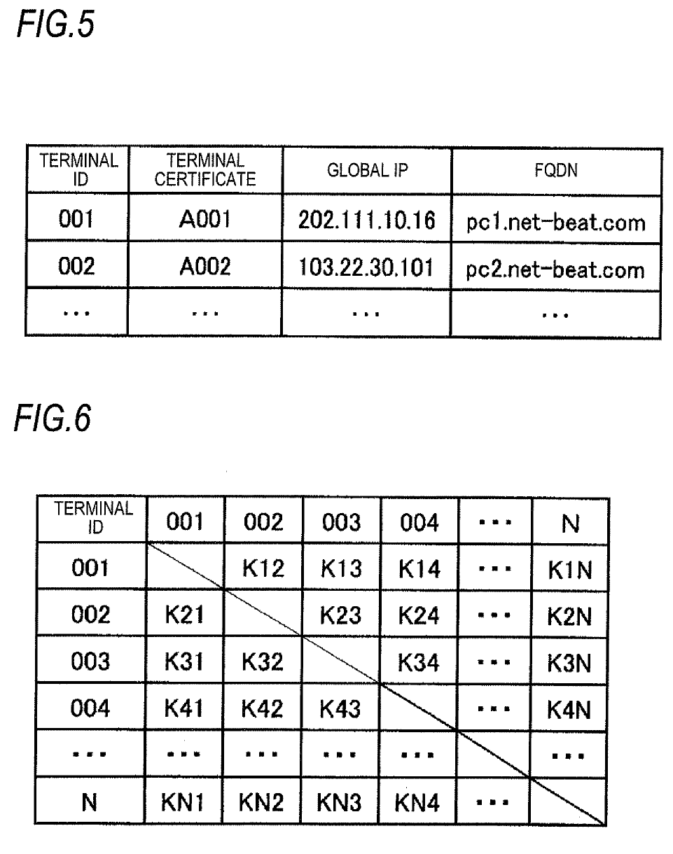

The key table storage unit 160 stores a key table indicating the session keys assigned to each other by the individual VPN terminals 20. FIG. 6 shows an example of the key table stored in the key table storage unit 160. In the key table in the example shown in FIG. 6, into the field located at the point of intersection between each row and each column, a session key is stored that has been assigned by the VPN terminal 20 having the terminal ID of the row to the VPN terminal 20 having the terminal ID of the column. For example, the value “K12” in the field located at the point of intersecting between the terminal ID “001” row and the terminal ID “002” column indicates the session key assigned by the VPN terminal 20-1 having the terminal ID “001” to the VPN terminal 20-2 having the terminal ID “002”. The session key “K12” is used in encryption of data to be transmitted from the VPN terminal 20-1 to the VPN terminal 20-2. Further, for example, the value “K21” in the field located at the point of intersecting between the terminal ID “002” row and the terminal ID “001” column indicates the session key assigned by the VPN terminal 20-2 to the VPN terminal 20-1. The session key “K21” is used in encryption of data to be transmitted from the VPN terminal 20-2 to the VPN terminal 20-1.

In response to a key registration request from the VPN terminal 20, the key registration unit 142 registers the session keys assigned by the VPN terminal 20 of requesting source to other VPN terminals 20, into the key table in the key table storage unit 160. For example, in the table in the example shown in FIG. 6, the data contents in the row corresponding to the terminal ID of the VPN terminal 20 of requesting source are registered. In response to a key acquisition request from a particular VPN terminal 20, the key transmitting unit 144 acquires from the key table in the key table storage unit 160 a list of session keys assigned to the VPN terminal 20 of requesting source by other VPN terminals 20, and then transmits the list to the VPN terminal 20 of requesting source. For example, in the table in the example shown in FIG. 6, the data contents in the column corresponding to the terminal ID of the VPN terminal 20 of requesting source are acquired and then transmitted.

The certificate related information storage unit 170 stores certificate related information concerning a certificate issued to the VPN-DNS server 10 by a certificate authority. The certificate related information contains, for example, a server certificate of the VPN-DNS server 10 issued by the certificate authority, a secret key corresponding to this server certificate, and a certificate of the certificate authority.

An example of the configuration of the VPN system has been described above. Then, an example of the operation of the VPN system is described below.

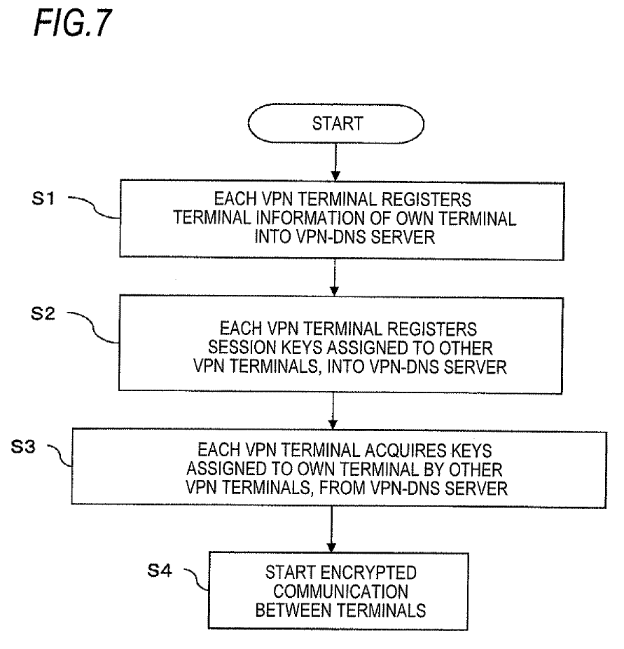

FIG. 7 is a flow chart showing an example of the procedure of processing to be performed by the time that encrypted communication is started between VPN terminals in the VPN system. The processing according to the procedure in the example shown in FIG. 7 is performed, for example, as initialization processing for establishing the VPN system.

With reference to FIG. 7, first, each VPN terminal 20 registers the terminal information of the own terminal into the VPN-DNS server 10 (step S1). As a result of the processing at step S1, for example, the data of the contents of the one row in FIG. 5 is stored into the terminal information DB 150 of the VPN-DNS server 10.

Next, each VPN terminal 20 acquires from the VPN-DNS server 10 the list of the terminal information of other VPN terminals 20, then assigns a session key to each VPN terminal 20 in the acquired list, and then registers into the VPN-DNS server 10 the session keys assigned to these other VPN terminals 20 (step S2). As a result of the processing at step S2, for example, the key table shown in FIG. 6 is stored into the key table storage unit 160 of the VPN-DNS server 10. Further, into the key DB 220 of each VPN terminal 20, for example, each record in the table in the example shown in FIGS. 3A and 3B is registered so that the values of terminal ID, transmission key, global IP and FQDN in each record are set up. Here, at this time point, the value of the item of receiving key is not yet set up in each record in the table in the example shown in FIGS. 3A and 3B.

After the above-mentioned step S2, each VPN terminal 20 acquires from the VPN-DNS server 10 the session keys assigned to the own terminal by other VPN terminals 20 (step S3). As a result of the processing at step S3, in the key DS 220 of each VPN terminal 20, for example, a value is set into the item of receiving key in each record in the table shown in FIGS. 3A and 3B.

As a result of the processing at steps S1 to S3, the information concerning the VPN terminals 20-1, 20-2, . . . , and 20-N connected to the VPN-DNS server 10 is registered into the VPN-DNS server 10. Simultaneously, exchange of a session key to be used in communication is achieved between each VPN terminal 20 and each of other VPN terminals 20.

After that, encrypted communication is started between the VPN terminals 20 (step S4).

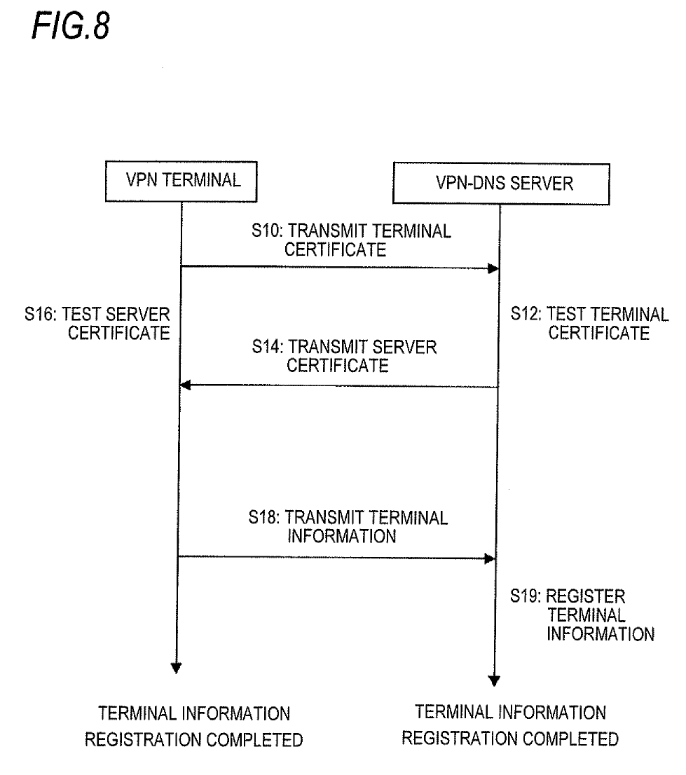

Next, an example of a detailed procedure of the processing performed at step S1 (terminal information registration processing), step S2 (key registration processing), and step S3 (key acquisition processing) in the example shown in FIG. 7 is described below with reference to FIGS. 8 to 10.

FIG. 8 is a diagram showing an example of a detailed procedure performed at step S1 (terminal information registration processing) shown in FIG. 7. The terminal information registration processing is performed mainly by the own-terminal information registration processing unit 202 of the NIF 200 of the VPN terminal 20 and the terminal information registration unit 130 of the VPN-DNS server 10. With reference to FIG. 8, first, the own-terminal information registration processing unit 202 of the VPN terminal 20 transmits to the VPN-DNS server 10 information that indicates requesting of terminal information registration, together with the terminal certificate of the own terminal read from the basic information storage unit 210 (step S10). The receiving unit 100 of the VPN-DNS server 10 having received the terminal information registration request including the terminal certificate transfers the received terminal information registration request to the controlling unit 120. Then, the controlling unit 120 transfers to the terminal information registration unit 130 the terminal certificate included in the received request. The terminal information registration unit 130 tests the received terminal certificate by using the certificate of the certificate authority in the certificate related information storage unit 170 (step S12). When the test has been passed, the terminal information registration unit 130 transmits the server certificate acquired from the certificate related information storage unit 170, to the VPN terminal 20 of requesting source via the controlling unit 120 and the transmitting unit 110 (step S14). Here, when the test has been failed, the terminal information registration unit 130 notifies the controlling unit 120 that the test of the terminal certificate has been failed. The controlling unit 120 having received the notification returns information that indicates failure of test, to the VPN terminal 20 of requesting source via the transmitting unit 110. Then, the processing is terminated.

When receiving the server certificate from the VPN-DNS server 10, the own-terminal information registration processing unit 202 of the VPN terminal 20 tests the received server certificate by using the certificate of the certificate authority stored in the basic information storage unit 210 (step S16). When the test of the server certificate has been passed, the own-terminal information registration processing unit 202 encrypts with the public key of the VPN-DNS server 10 the terminal information of the own terminal read from the basic information storage unit 210, and then transmits the information to the VPN-DNS server 10 (step S18). The terminal information transmitted at step S18 contains, for example, the terminal ID, the global IP, and the FQDN of the VPN terminal 20. Here, when the test has been failed, the own-terminal information registration processing unit 202 does not transmit the terminal information, and then transmits information that indicates the test of the server certificate has been failed, to the VPN-DNS server 10. Then, the processing is terminated.

In the VPN-DNS server 10 having received the encrypted terminal information from the VPN terminal 20, the terminal information registration unit 130 decrypts the terminal information received via the receiving unit 100 and the controlling unit 120, by using the secret key corresponding to the server certificate of the VPN-DNS server 10 in the certificate related information. Then, a record corresponding to the VPN terminal 20 of requesting source (see FIG. 5) is generated in the terminal information DB 150. In the generated record, the values of individual items contained in the terminal information received from the VPN terminal 20 are registered into the items of terminal ID, global IP, and FQDN. Further, the terminal certificate received at step S10 is registered into the item of certificate in the record (the processing described so far is step S19). When step S19 is completed, the terminal information registration processing according to the procedure in the example shown in FIG. 8 is completed.

Here, for example, the VPN-DNS server 10 may acquire in advance a list of VPN terminals 20 to be registered. Then, in the processing according to the procedure in the example shown in FIG. 8, only when the test of the terminal certificate has been passed and the terminal ID of the requesting source terminal is included in the list having been acquired in advance, the VPN-DNS server 10 may register into the terminal information DB 150 the terminal information received from the VPN terminal 20. The list of VPN terminals 20 to be registered may be, for example, acquired from the certificate authority as a list of VPN terminals 20 to which the certificate authority has issued a certificate.

When each of the VPN terminals 20-1, 20-2, . . . , and 20-N performs terminal information registration processing with the VPN-DNS server 10 according to the procedure in the example shown in FIG. 5, as a result, the terminal information of the N VPN terminals 20 is registered into the terminal information DB 150 of the VPN-DNS server 10.

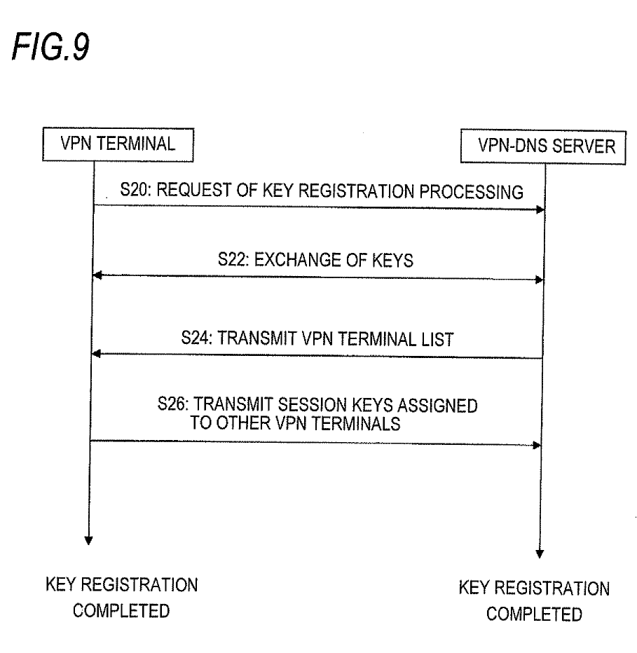

Next, an example of a detailed procedure of the key registration processing at step S2 in FIG. 7 is described below with reference to FIG. 9. The key registration processing according to the procedure shown in FIG. 9 is performed mainly by the key registration processing unit 204 of the VPN terminal 20 and the key registration unit 142 of the key processing unit 140 of the VPN-DNS server 10. With reference to FIG. 9, first, the key registration processing unit 204 of the NIF 200 of the VPN terminal 20 transmits to the VPN-DNS server 10 a key registration processing request that requests the start of key registration processing (step S20). In accordance with this request, a common key is exchanged between the VPN-DNS server 10 and the VPN terminal 20 of requesting source (step S22). The key exchange processing at step S22 is performed, for example, in accordance with a key exchange algorithm such as RSA key exchange and Diffie-Hellman key exchange.

When the exchange of a common key is completed, the key registration unit 142 of the key processing unit 140 of the VPN-DNS server 10 acquires from the terminal information DB 150 the terminal information of the VPN terminals 20 other than the VPN terminal 20 of requesting source among the terminal information registered in the terminal information DB 150. Then, a list of the acquired terminal information is encrypted by using the common key exchanged at step S22, and then transmitted to the VPN terminal 20 of requesting source via the controlling unit 120 and the transmitting unit 110 (the processing described so far is step S24). For example, when the VPN terminal 20-1 serves as the requesting source, a list of the terminal information of the VPN terminals 20-2, . . . , and 20-N is transmitted at step S24.

In the VPN terminal 20 having received the encrypted list of the terminal information from the VPN-DNS server 10, the key registration processing unit 204 decrypts the received list of the terminal information by using the common key exchanged at step S22. Then, the key registration processing unit 204 generates in the key DB 220 a record corresponding to each VPN terminal 20 described in the received list. In the above-mentioned example in which the VPN terminal 20-1 serves as the requesting source, as shown in the table in the example shown in FIG. 3A, records having terminal IDs “002”, . . . , and “N” corresponds to the individual VPN terminals 20-2, . . . , and 20-N are generated in the key DB 220. Further, in each generated record, the values of individual items in the terminal information described in the list received from the VPN-DNS server 10 are registered into the items of terminal ID, global IP, and FQDN. Then, the key registration processing unit 204 generates a session key to be assigned to each VPN terminal 20 registered in the key DB 220, and then registers the generated session key into the item of transmission key in the record corresponding to each VPN terminal 20. Further, the key registration processing unit 204 generates a list of session keys in which correspondence is established between the terminal ID of each VPN terminal 20 registered in the key DB 220 and the session key assigned to this VPN terminal 20. Then, the generated list of session keys is encrypted with the above-mentioned common key, and then transmitted to the VPN-DNS server 10 (the processing described so far is step S26). In the above-mentioned example in which the VPN terminal 20-1 serves as the requesting source, a list {K12, K13, . . . , K1N} of the session keys assigned by the VPN terminal 20-1 to the VPN terminals 20-2, . . . , and 20-N is transmitted at step S26 together with the terminal IDs corresponding to the individual session keys.

When receiving via the receiving unit 100 and the controlling unit 120 the list of session keys transmitted from the VPN terminal 20, the key registration unit 142 of the key processing unit 140 of the VPN-DNS server 10 decrypts the list by using the above-mentioned common key, and then registers the session keys described in the received list into the key table in the key table storage unit 160. For example, when the key table shown in FIG. 6 is stored in the key table storage unit 160, in the table in the example shown in FIG. 6, each session key in the list is registered into the row corresponding to the terminal ID of the VPN terminal 20 of requesting source.

In the VPN-DNS server 10, when registration of the session keys into the key table is completed, the processing according to the procedure in the example shown in FIG. 9 is completed.

When each of the VPN terminals 20-1, 20-2, . . . , and 20-N performs key registration processing with the VPN-DNS server 10 according to the procedure in the example shown in FIG. 9, as a result, the key table of the VPN-DNS server 10 is constructed.

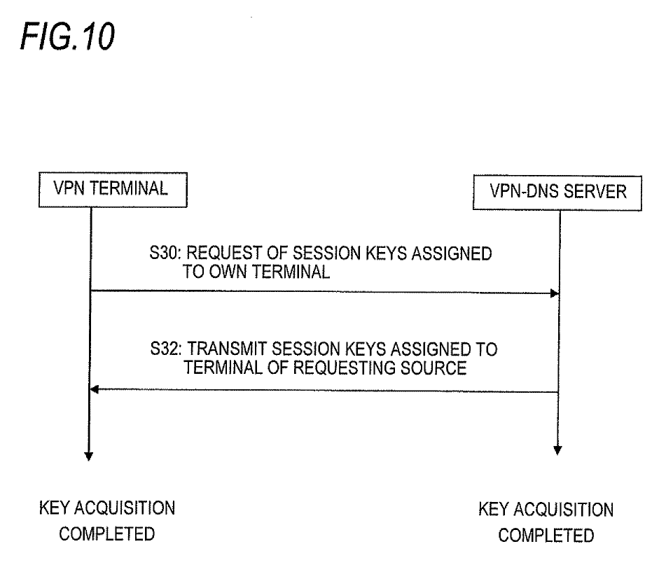

Next, an example of a detailed procedure of the key acquisition processing at step S3 in FIG. 7 is described below with reference to FIG. 10. The key acquisition processing according to the procedure shown in FIG. 10 is performed mainly by the key acquisition processing unit 206 of the VPN terminal 20 and the key transmitting unit 144 of the key processing unit 140 of the VPN-DNS server 10. With reference to FIG. 10, first, the key acquisition processing unit 206 of the NIF 200 of the VPN terminal 20 requests to the VPN-DNS server 10 the transmission of session keys assigned to the own terminal by other VPN terminals 20 (step S30).

The receiving unit 100 of the VPN-DNS server 10 having received this request transfers the received request to the controlling unit 120. Then, the controlling unit 120 instructs the key the transmitting unit 144 of the key processing unit 140 such as to perform transmission processing for the session keys. Then, the key the transmitting unit 144 refers to the key table storage unit 160 so as to acquire a list of session keys assigned to the VPN terminal 20 of requesting source by other VPN terminals 20. For example, in a case that the key table shown in FIG. 6 is stored in the key table storage unit 160, when a transmission request for session keys is received from the VPN terminal 20-1, the data contents in the column of terminal ID “001” in the table in the example shown in FIG. 6 are acquired. Then, by using the common key obtained in the key exchange processing performed with the VPN terminal 20 of requesting source at step S22 in FIG. 9, the key the transmitting unit 144 encrypts the list of session keys acquired from the key table, and then transfers the list to the controlling unit 120. The controlling unit 120 transmits the encrypted list of session keys to the VPN terminal 20 of requesting source via the transmitting unit 110 (the processing described so far is step S32).

In the VPN terminal 20 having received the encrypted list of session keys from the VPN-DNS server 10, by using the common key obtained in the key exchange processing at step S22 in FIG. 9, the key acquisition processing unit 206 of the NIF 200 decrypts the received list of session keys, and then registers each session key described in the received list into the item of receiving key in the record corresponding to each VPN terminal 20 in the key DB 220. When this registration processing is completed, the processing according to the procedure in the example shown in FIG. 10 is completed.

Each of the VPN terminal 20-1, 20-2, . . . , and 20-N performs the key acquisition processing with the VPN-DNS server 10 in accordance with the procedure in the example shown in FIG. 10, and then registers, into the own key DB 220, each of the session keys assigned by other VPN terminals 20 as a receiving key corresponding to the terminal ID of each of other VPN terminals 20.

As described above, when each of the N VPN terminals 20-1, 20-2, . . . , and 20-N executes the processing described above with reference to FIGS. 9 and 10, as a result, exchange of a common key is achieved in each combination of two VPN terminals 20 among the N VPN terminals 20. When each VPN terminal 20 performs communication with the VPN-DNS server 10 three times, that is, once at each of steps S1, S2, and S3, as a result, each VPN terminal 20 achieves exchange of a common key with each of other N-1 VPN terminals 20. Thus, as the entirety of the VPN system including the N VPN terminals 20, 3N times of communication is sufficient to achieve the exchange of common keys in all combinations of two terminals among the N terminals.

Here, the above-mentioned description has been given for a case that at each of steps S1, S2, and S3 in FIG. 7, processing at the subsequent step is performed after the processing between all of the N VPN terminals 20 and the VPN-DNS server 10 is completed at the present step. However, in each VPN terminal 20, a situation is not always realized that processing at the subsequent step is executed after the processing at each step is completed for all of the N VPN terminals 20. For example, a situation can arise that before the terminal information registration processing (step S1) performed by a part of VPN terminals 20 is completed, an other VPN terminal 20 executes the key registration processing (step S2). Alternatively, for example, a situation can arise that before the key registration processing (step S2) performed by a part of VPN terminals 20 is executed, an other VPN terminal 20 executes the key acquisition processing (step S3). Further, for example, a situation can arise that a new VPN terminal 20 is connected to the VPN system or alternatively that the IP address or the terminal certificate of an already registered VPN terminal 20 is updated. In these situations described above, after the VPN terminal 20 executes the key registration processing (step S2) or the key acquisition processing (step S3) so that the data is registered into key DB 220, at least one of the terminal information DB 150 and the key table storage unit 160 of the VPN-DNS server 10 is updated.

In order that the update in the terminal information DB 150 and the key table storage unit 160 of the VPN-DNS server 10 should be reflected in the data contents in the key DB 220, each VPN terminal 20 inquires to the VPN-DNS server 10 the presence or absence of update in the terminal information DB 150 and the key table storage unit 160, for example, periodically or at a timing set up in advance (e.g., at the time of startup of the VPN terminal 20). Then, for example, when update has occurred in the data contents in the terminal information DB 150 or the key table storage unit 160 during the period from the last inquiry to the present inquiry for the presence or absence of update placed by this terminal, the VPN-DNS server 10 having received this inquiry transmits information that indicates the contents of the update, to the VPN terminal 20. At that time, the search for the presence or absence of update having been performed by the VPN-DNS server 10 is realized such that, for example, update date and time for the record corresponding to each VPN terminal 20 in the terminal information DB 150 is recorded and that in the key table storage unit 160, update date and time is recorded for each record (e.g., each row and each column in the table in the example shown in FIG. 6) in the key table. For example, in the record corresponding to each VPN terminal 20 in the terminal information DB 150, the date and time of the last update inquiry placed by the terminal is further stored. Then, the presence or absence of updated record during the period after the date and time of the last update inquiry to the date and time of the present inquiry is searched for in the terminal information DB 150 and the key table. Then, a record of search result is returned as the contents of the update to the VPN terminal 20. In accordance with the information acquired from the VPN-DNS server 10, the VPN terminal 20 updates the key DB 220. Further, when a VPN terminal 20 having not yet performed assignment of session keys is registered into the VPN-DNS server 10, the VPN terminal 20 executes the key registration processing (step S2) for this VPN terminal 20, and then acquires session keys assigned by the VPN terminal 20, at the key acquisition processing (step S3).

Further, for example, when a change arises in the own-terminal information (e.g., a change in the IP address and update of the terminal certificate), each VPN terminal 20 performs processing similar to the terminal information registration processing (step S1) so as to transmit the updated own-terminal information to the VPN-DNS server 10, and thereby updates its own terminal information registered in the terminal information DB 150 of the VPN-DNS server 10.

Here, for example, when update occurs in the terminal information DB 150 or the storage unit 160, the VPN-DNS server 10 may notify this situation to each VPN terminal 20. Then, the VPN terminal 20 having received this notification performs processing corresponding to the notified contents of the update. For example, in the case of update of the terminal information of an already registered VPN terminal 20, in the VPN terminal 20, the terminal information in the corresponding key DB 220 is updated. Further, for example, in a case that a new VPN terminal 20 is registered into the VPN-DNS server 10, in each VPN terminal 20, the key registration processing (step S2) and the key acquisition processing (step S3) are executed for the new VPN terminal 20.

Next, an example of the processing in encrypted communication (step S4 in FIG. 7) between VPN terminals 20 is described below.

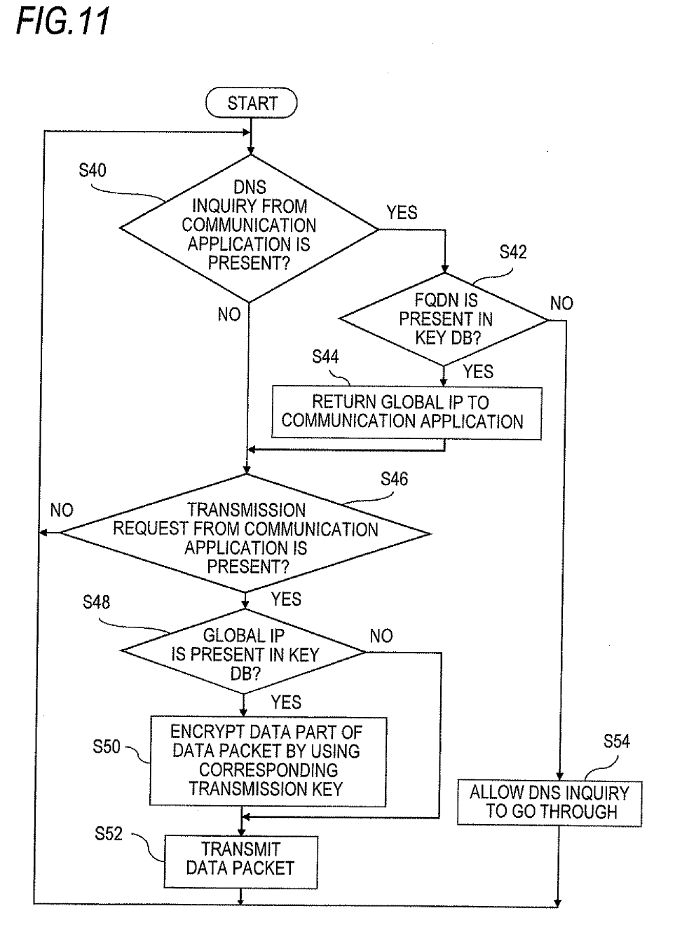

FIG. 11 is a flow chart showing an example of the procedure of the processing performed by the communication processing unit of the NIF 200 of the VPN terminal 20 in a case that the VPN terminal 20 transmits data to another VPN terminal 20.

With reference to FIG. 11, when the communication application 230 is to communicate with a counterpart specified by an FQDN, first, DNS inquiry is performed to a DNS server (outside the present system). The communication processing unit 208 determines the presence or absence of a DNS inquiry from the communication application 230 (step S40). When transmission of data is desired, for example, the communication application 230 receives specification of the FQDN of a VPN terminal 20 of transmission destination, and then inquires the global IP corresponding to this FQDN to the DNS server through the communication processing unit 208 of the NIF 200. At step S40, the presence or absence of this inquiry is determined. When a DNS inquiry is absent, the procedure goes to step S46.

When a DNS inquiry from the communication application 230 is detected (YES at step S40), the communication processing unit 208 determines whether the FQDN specified in the DNS inquiry is registered in the key DB 220 (step S42). At step S42, the processing is achieved, for example, by determining whether a record whose value of the item of FQDN is equal to the FQDN specified in the DNS inquiry is present among the records corresponding to the individual VPN terminals 20 in the key DB 220.

When a record containing the FQDN specified in the DNS inquiry is absent in the key DB 220 (NO at step S42), the communication processing unit 208 allows the DNS inquiry to pass through (step S54), and then returns to step S40 so as to await a further DNS inquiry. The fact that the FQDN is absent in the records indicates that this FQDN is not of a VPN terminal in the present VPN system. Thus, the passed DNS inquiry is sent to a DNS server present on the Internet. Then, an IP address is returned from the DNS server.

On the other hand, when a record containing the FQDN specified in the DNS inquiry is present in the key DB 220 (YES at step S42), the communication processing unit 208 returns to the communication application 230 the value registered in the item of global IP in the record (step S44). When acquiring the global IP from the communication processing unit 208, the communication application 230 generates a data packet whose destination IP address is equal to the acquired global IP and whose source IP address is equal to the global IP of the own terminal, and then transfers to the communication processing unit 208 the generated data packet together with a transmission request.

At step S46, the communication processing unit 208 determines whether a transmission request accompanied by a data packet has been received from the communication application 230. When no transmission request has been received, the procedure returns to the determination at step S40.

When there a transmission request has been received from the communication application (YES at step S46), the communication processing unit 208 determines whether the global IP serving as the destination IP address in the data packet that accompanies the transmission request is registered in the key DB 220 (step S48). This determination is achieved, for example, by determining whether a record whose value of the item of global IP is equal to the global IP serving as the destination IP address is present among the records in the key DB 220.

When the global IP serving as the destination IP address is not registered in the key DB 220 (NO at step S48), the communication processing unit 208 transmits to the network 30 the data packet received from the communication application 230 (step S52). Then, the procedure returns to the determination at step S40.

When a record containing the global IP serving as the destination IP address is present in the key DB 220 (YES at step S48), the encryption unit 2080 of the communication processing unit 208 encrypts the data part in the data packet received from communication application, by using the session key registered in the item of transmission key in the record (step S50).

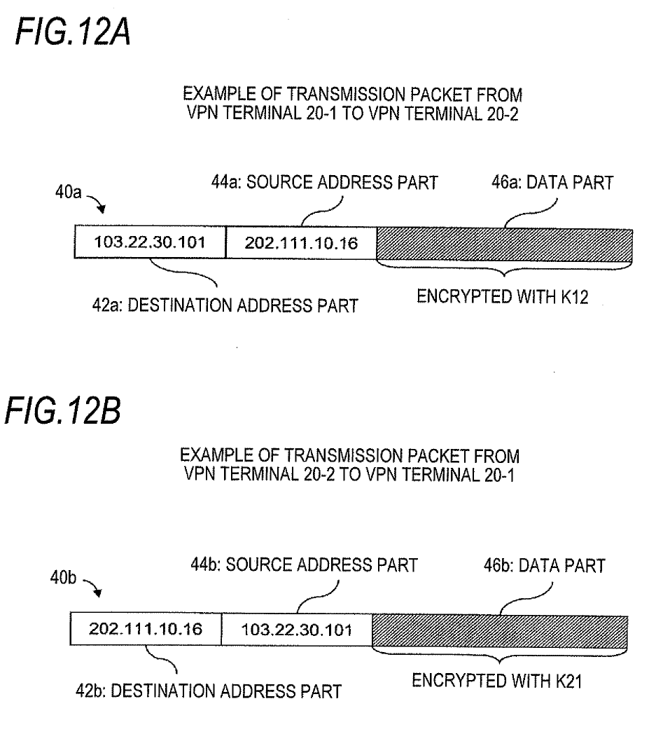

FIGS. 12A and 12B show examples of the encrypted-data containing data packet generated at step S50. FIG. 12A shows an example of a data packet generated by the communication processing unit 208 of the VPN terminal 20-1 and then transmitted to the VPN terminal 20-2. On the other hand, FIG. 12B shows an example of a data packet generated by the communication processing unit 208 of the VPN terminal 20-2 and then transmitted to the VPN terminal 20-1. Each of the data packets 40 shown in FIGS. 12A and 12B has a destination address part 42, a source address part 44, and a data part 46. The destination address part 42a of the data packet 40a in the example shown in FIG. 12A contains the global IP “103.22.30.101” of the VPN terminal 20-2 of transmission destination. The source address part 44a contains the global IP “202.111.10.16” of the VPN terminal 20-1 of transmission source. Further, the data part 46a of the data packet 40a contains data encrypted with the transmission key “K12” corresponding to the VPN terminal 20-2 having the terminal ID “002” in the key DB 220 (see FIG. 3A) of the VPN terminal 20-1. Further, the destination address part 42b of the data packet 40b in the example shown in FIG. 12B contains the global IP of the VPN terminal 20-1, while the source address part 44b contains the global IP of the VPN terminal 20-2. Further, the data part 46b data encrypted with the transmission key “K21” corresponding to the VPN terminal 20-l (having the terminal ID “001”) of transmission destination in the key DOB 220 (FIG. 3B) of the VPN terminal 20-2.

Description is returned to FIG. 11. When encryption of the data part (step S50) is completed, the communication processing unit 208 transfers to the network 30 the data packet containing the encrypted data part (step S52). After this step S52, the procedure returns to the determination at step S40.

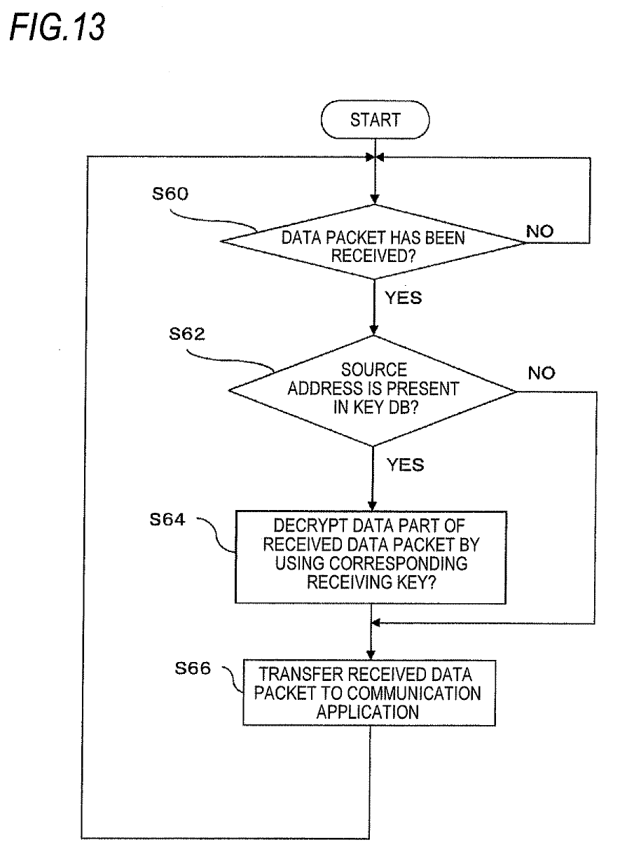

Next, with reference to FIG. 13, description is given for an example of the procedure of processing performed by the communication processing unit 208 of the NIF 200 of the VPN terminal 20 when a VPN terminal 20 receives data from an apparatus such as another VPN terminal 20.

The communication processing unit 208 determines whether a data packet addressed to the own terminal has been received through the network 30 (step S60). When no data packet is received, the determination at step S60 is repeated.

When data has been received (YES at step S60), the communication processing unit 208 refers to the key DB 220 and thereby determines the presence or absence of a record that contains as a global IP the source address specified in the received data packet (step S62). When a record that contains the source address as a global IP is absent in the key DB 220 (NO at step S62), the communication processing unit 208 transfers the received data packet intact to the communication application (step S66).

When a record that contains the source address as a global IP is present in the key DB 220 (YES at step S62), the data part of the received data packet is decrypted by using the session key registered in the item of receiving key in the record (step S64). Then, a data packet containing the decrypted data part is transferred to the communication application (step S66).

After this step S66, the procedure returns to the determination at step S60.

When the source address of the data packet received by the communication processing unit 208 of the VPN terminal 20 contains a global IP registered in the key DB 220, this fact indicates that the data packet has been transmitted by any one of other VPN terminals 20. Accordingly, the data in the data part of the data packet has been encrypted by using the session key assigned by the VPN terminal 20 of transmission source to the VPN terminal 20 having received the data packet. In the key DB 220 of the VPN terminal 20, session keys assigned to the own terminal by other VPN terminals 20 are registered as “receiving keys” in a correspondence manner to the terminal IDs of the individual other VPN terminals 20. Thus, when the procedure goes from step S62 to step S64 in FIG. 13 so that the data is decrypted by using the receiving key corresponding to the VPN terminal 20 of transmission source in the key DB 220, unencrypted data is obtained. For example, in a case that the VPN terminal 20-2 receives the data packet transmitted from the VPN terminal 20-1 to the VPN terminal 20-2 in the example shown in FIG. 12A and that the processing according to the procedure in the example shown in FIG. 13 is performed by the communication processing unit 208 of the VPN terminal 20-2, in the determination at step S62, a record that contains the source address “202.111.10.16” as a global IP is searched for in the key DB 220. In this record in the table shown in FIG. 3B illustrating an example of the key DB 220 of the VPN terminal 20-2, the session key “K12” assigned by the VPN terminal 20-1 to the VPN terminal 20-2 is registered as the receiving key. The data part 46 of the data packet 40 transmitted from the VPN terminal 20-1 to the VPN terminal 20-2 is encrypted with the session key “K12”. Thus, the VPN terminal 20-2 acquires unencrypted data as a result of the decryption using this session key.

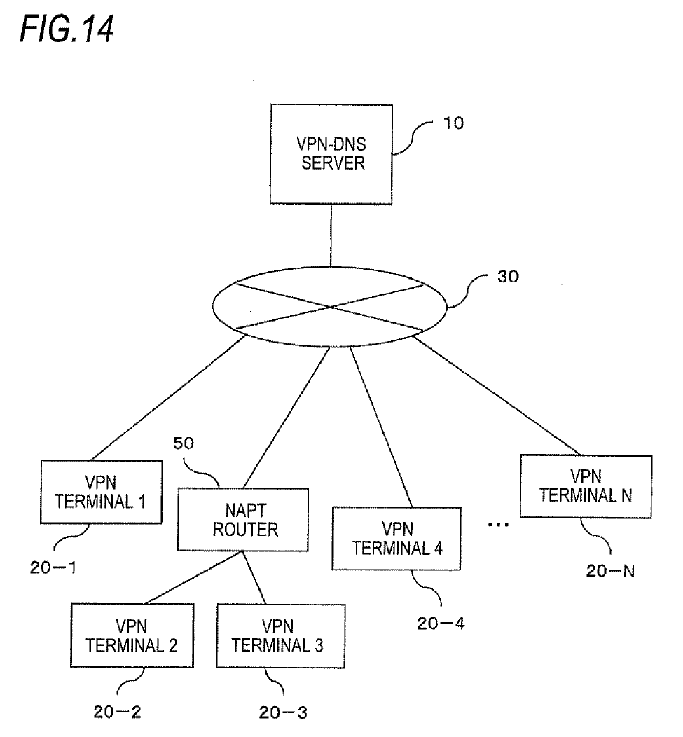

In the example of a VPN system according to the exemplary embodiment described above, each VPN terminal 20 has a global IP. In another example of a VPN system, a plurality of VPN terminals 20 that constitute a part of the N VPN terminals may be connected to a router having a NAPT (Network Address Port Translation) function so as to share one global IP. FIG. 14 shows an example of the configuration of a VPN system according to this approach.

In the VPN system in the example shown in FIG. 14, a VPN-DNS server 10, a NAPT router 50, and VPN terminals 20-1, 20-4, . . . , and 20-N are connected through a network 30. Further, a VPN terminal 20-2 and a VPN terminal 20-3 are connected to the network 30 via the NAPT router 50, and share one global IP. The NAPT router 50 assigns mutually different port numbers to the VPN terminal 20-2 and the VPN terminal 20-3, respectively. This permits identification of data transmitted or received by each of these terminals. For example, in a case that the VPN terminal 20-2 (or 20-3) transmits data, the transmission data packet from the terminal contains a source address and a source port number. Then, the value of the source address is the local IP address (an IP address which is unique among the VPN terminals 20 connected to the NAPT router 50 but has a possibility of duplication between apparatuses connected to the network 30) of the VPN terminal 20-2 (or 20-3). When receiving the above-mentioned transmission data packet from the VPN terminal 20-2 (or 20-3), the NAPT router 50 converts the source address in the transmission data packet into the global IP of the NAPT router 50 and converts the source port number into the port number assigned to each terminal, and then transfers the packet to the network 30. In the data packet replied to each terminal in response to this transmission data from the VPN terminal 20-2 (or 20-3), the destination address and the transmission destination port number are equal to the global IP of the NAPT router 50 and the port number assigned to each terminal, respectively. When receiving this data packet, the NAPT router 50 converts the destination address in the data packet into the local IP address of the terminal corresponding to the transmission destination port number in the data packet, and then transmits the converted data packet to the destination address. By virtue of this, the data packet reaches the VPN terminal 20-3 (or 20-2) serving as the corresponding transmission destination.

Here, in the example shown in FIG. 14, each of the VPN terminals 20-1, 20-4, . . . , and 20-N other than the VPN terminals 20-2 and 20-3 has a global IP.

Also in the VPN system having the configuration shown in FIG. 14, similarly to the VPN system having the configuration in the example shown in FIG. 1, when the terminal information registration processing (step S1 in FIG. 7; FIG. 8), the key registration processing (step S2 in FIG. 7; FIG. 9) and the key acquisition processing (step S3 in FIG. 7; FIG. 10) are performed, exchange of common keys to be used in encrypted communication between individual VPN terminals 20 is achieved. That is, in the VPN-DNS server 10, the terminal information of the individual N VPN terminals 20 is registered in the terminal information DB 150, while the key table is registered in the key table storage unit 160. Further, in the key DB 220 of each of the N VPN terminals 20, transmission keys and receiving keys each corresponding to each of other N-1 VPN terminals 20 are registered.

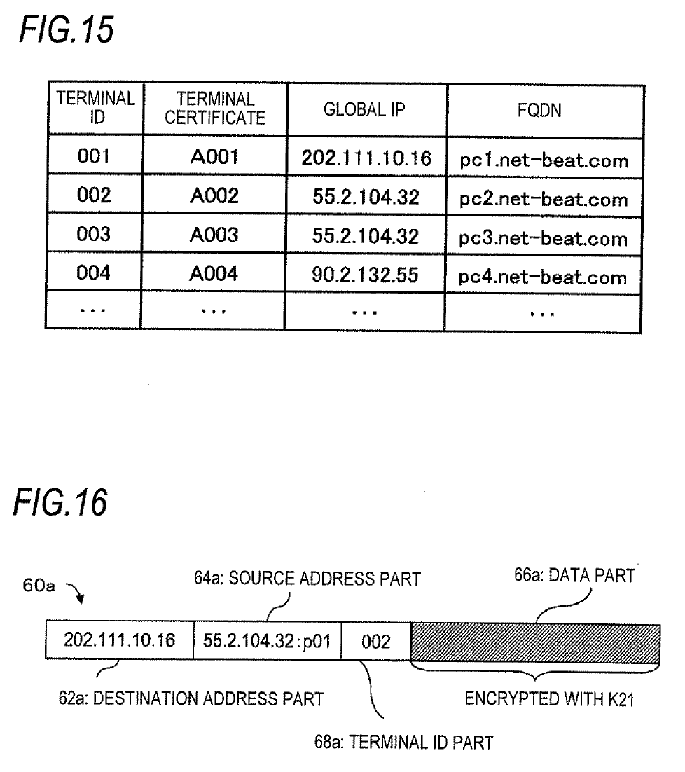

FIG. 15 shows an example of data contents in the terminal information DB 150 of the VPN-DNS server 10 after the terminal information registration processing is executed in the VPN system in the example shown in FIG. 14. With reference to FIG. 15, the items in each record to be registered in the terminal information DB 150 are similarly to those in the table in the example shown in FIG. 5. Here, in the table in the example shown in FIG. 15, the global IPs of the VPN terminals 20-2 and 20-3 (having the terminal IDs “002” and “003”, respectively) have a common value equal to the global IP “155.2.104.32” of the NAPT router 50.

In an other VPN terminal 20 having received encrypted data from the VPN terminal 20-2 or 20-3 having a common global IP, in order that the encrypted data should be decrypted, the VPN terminal 20 of transmission source of the received data packet need be identify and the receiving key to be used in decryption need be identified. At that time, the source address alone in the received data packet is insufficient for identifying which of the VPN terminals 20-2 and 20-3 sharing a global IP is the terminal of transmission source. Thus, when data is to be transmitted, the communication processing unit 208 of each VPN terminal 20 in the VPN system in the example shown in FIG. 14 transmits a data packet generated by incorporating the terminal ID of the own terminal in addition to the destination address part 42, the source address part 44, and the data part 46 in the data packet 40 shown in FIGS. 12A and 12B.

FIG. 16 shows an example of a data packet transmitted by each VPN terminal 20 shown in FIG. 14. FIG. 16 illustrates an example of a data packet transmitted from the VPN terminal 20-2 to the VPN terminal 20-1. With reference to FIG. 16, the data packet 60a has a destination address part 62a, a source address part 64a, a data part 66a, and a terminal ID part 68a. The destination address part 62a contains the global IP “202.111.10.16” of the VPN terminal 20-1 serving as the data transmission destination. Further, the source address part 64a contains: the global IP “55.2.104.32” of the NAPT router 50 connected to the VPN terminal 20-2 serving as the transmission source; and the port number “p01” assigned to the VPN terminal 20-2 by the NAPT router 50. The value in the source address part 62a is set up when the NAPT router 50 performs transformation processing of the source address and the port number as described above. The data part 66a is encrypted with the session key “K21” assigned by the VPN terminal 20-2 serving as the transmission source to the VPN terminal 20-1 serving as the transmission destination. Further, the terminal ID part 68a of the data packet 60a contains the terminal ID “002” of the VPN terminal 20-2 serving as the transmission source.

The VPN terminal 20-1 having received the data packet 60a shown in FIG. 16 searches the key DB 220 with adopting as the search key the terminal ID “002” contained in the terminal ID part 68a, and thereby acquires the receiving key “K21” to be used in decryption of the data part 66a.

As shown in the example in FIG. 16, when each VPN terminal 20 transmits a data packet containing the terminal ID of the own terminal, an other VPN terminals 20 having received the packet identifies the terminal of transmission source on the basis of the terminal ID in the data packet. Thus, even when a plurality of VPN terminals 20 have the global IP value equal to the source address in the received data packet, the VPN terminal 20 having received the data packet can identify the VPN terminal 20 of transmission source, and hence can identify the corresponding receiving key.

Further, when data is to be transmitted to any one of a plurality of VPN terminals 20 that share one global IP, the communication processing unit 208 of each VPN terminal 20 specifies the VPN terminal 20 of transmission destination by using the port number assigned to the VPN terminal 20 by the NAPT router 50 in addition to the global IP used by the VPN terminal 20 of transmission destination. By virtue of this, the transmission key to be used in encryption of transmission data is specified. Thus, when the data packet 60a that contains a global IP and a port number in the source address part 62a is received, the communication processing unit 208 of each VPN terminal 20 in the VPN system in the example shown in FIG. 14, in the key DB 220, the port number in the source address part 62a is registered into the record corresponding to the terminal ID in the terminal ID part 68a of the data packet 60a.

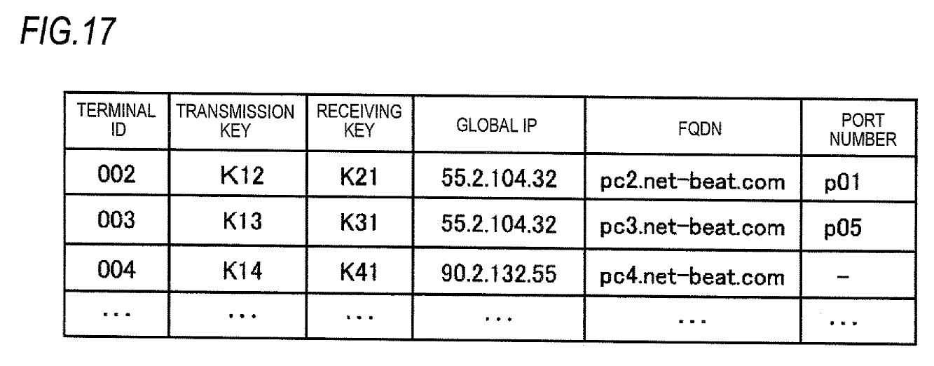

FIG. 17 shows an example of data contents in the key DB 220 of each VPN terminal 20 of the VPN system in the example shown in FIG. 14. FIG. 17 illustrates an example of data contents in the key DB 220 of the VPN terminal 20-1 shown in FIG. 14. The key DB 220 in the example shown in FIG. 17 has the item of port number in a correspondence manner to the terminal ID of each VPN terminal 20, in addition to the items in the table in the example shown in FIGS. 3A and 3B. The value of the item of port number is registered when the VIN terminal 20-1 receives a data packet containing the terminal ID of the corresponding record. For example, when the VPN terminal 20-1 receives from the VPN terminal 20-2 the data packet 60a shown in the example in FIG. 16, the communication processing unit 208 of the VPN terminal 20-1 sets the port number “p01” contained in the source address part 64a of the data packet 60a into the item of port number in a key DB 220 record corresponding to the terminal ID “002” in the data packet 60a. Here, in general, a private IP address is assigned to each terminal located under a NAPT router. Thus, whether the own terminal ID should be incorporated into the data packet may be determined on the basis of whether the IP address of the own terminal is a global IP address. Nevertheless, in some cases, a global IP address is assigned to a terminal located under a NAPT router. Thus, in this case, when every terminal incorporates the own terminal ID into the data packet, the processing of encryption and decryption can be achieved appropriately.

The following description is given for an example of processing in which the VPN terminal 20-1 receives from the VPN terminal 20-2 the data packet 60a shown in the example in FIG. 16, and that in response to this received data packet, data is transmitted to the VPN terminal 20-2. Here, the basic procedure of the processing performed in data receiving and transmission by the communication processing unit 208 is similar to that of the flow chart shown in FIGS. 13 and 11.

First, an example of the processing of data receiving is described below. When the data packet 60a shown in the example in FIG. 16 is received, in the key DB 220 of the VPN terminal 20-1, the port number “p01” is registered into the record having the terminal ID “002” as described above (FIG. 17). This registration is performed, for example, after the YES path of the determination at step S62 and before the data decryption (step S64) in the procedure in the example shown in FIG. 13. Further, the decryption unit 2082 of the communication processing unit 208 of the VPN terminal 20-1 decrypts the data part 66a of the data packet 60a with the receiving key “K21” corresponding to the terminal ID “002” (step S64). Then, the communication processing unit 208 transfers the decrypted data packet 60a to the communication application (step S66).

In response to this, the communication application generates a data packet to be transmitted as a response to the VPN terminal 20-2, and then issues to the communication processing unit 208 a transmission request accompanied by the generated data packet. This data packet contains as the destination address and the destination port number the source address “55.2.104.32” and the port number “p01” contained in the source address part 64a in the data packet 60a received from the VPN terminal 20-2 as shown in FIG. 16. Further, the global IP “202.111.10.16” of the VPN terminal 20-1 is contained as the source address. The communication processing unit 208 adds the terminal ID “001” of the own apparatus to the data packet received together with the transmission request from the communication application. Then, the communication processing unit 208 acquires from the key DB 220 a session key to be used in encryption of data to be transmitted. At that time, the communication processing unit 208 searches the key DB 220 for a record containing the set of the destination address “155.2.104, 32” and the destination port number “p01” contained in the data packet, and thereby acquires the transmission key registered in the record of search result.

In the present example, the transmission key “K12” in the record having the terminal ID “002” in the table in the example shown in FIG. 17 is acquired. By using this transmission key “K12”, the encryption unit 2080 of the communication processing unit 208 encrypts the transmission data in the data packet.

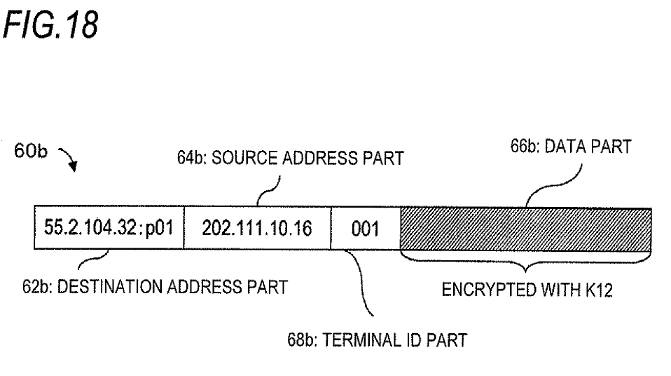

FIG. 18 shows an example of the encrypted data packet. The destination address part 62b of the data packet 60b in the example shown in FIG. 18 has values (an IP address and a port number) similar to those in the source address part 64a of the received data packet 60a (FIG. 16). The source address part 64b and the terminal ID part 68b contain the global IP and the terminal ID of the own terminal, respectively. The data part 66b is encrypted with the session key “K12” assigned by the VPN terminal 20-1 to the VPN terminal 20-2.

Here, a series of the above-mentioned processing for a data packet to be transmitted is performed, for example, at step S50 in the procedure shown in FIG. 11.

When the above-mentioned configuration is adopted in which the source port number in the received data packet is stored in the key DB 220 in a correspondence manner to the terminal ID of the VPN terminal 20 of transmission source, the VPN terminal 20 of transmission destination can be specified at the time of data transmission by searching the key DB 220 with adopting as the search key the set of the global IP and the port number of the transmission destination of the data to be transmitted.

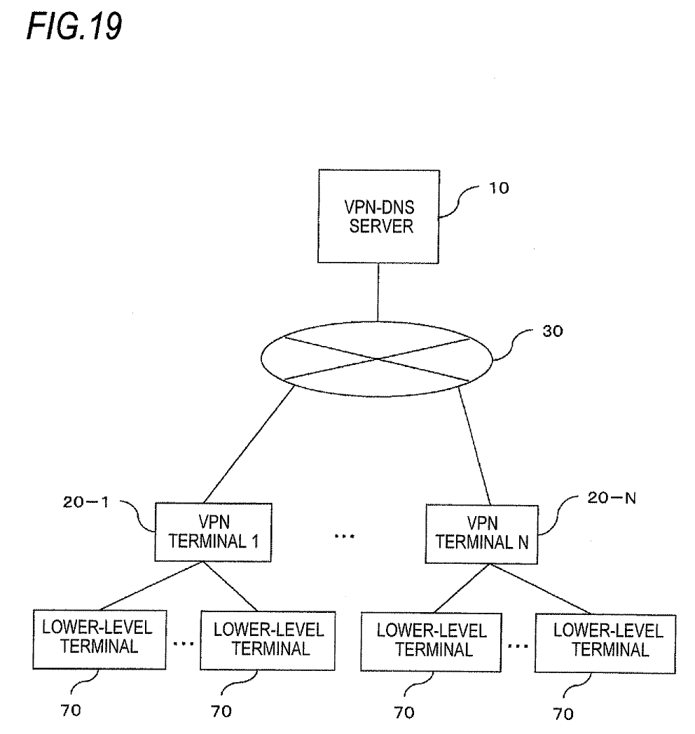

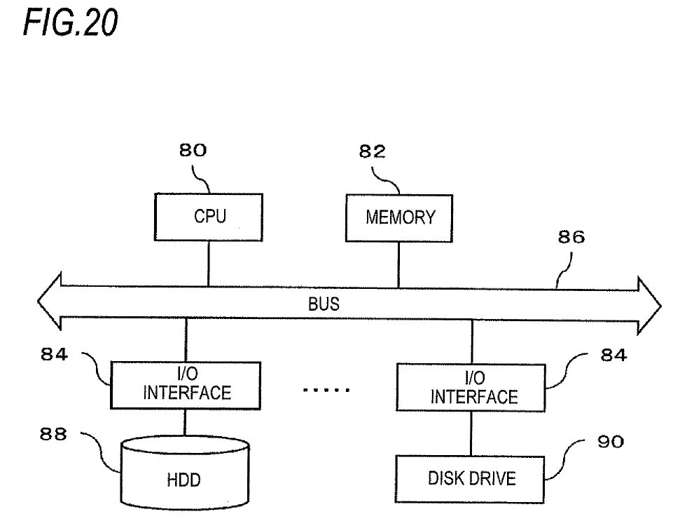

Further, in another example of the configuration of a VPN system, each VPN terminal 20 may serve as a VPN gateway apparatus so as to perform tunneling of communication packets for the terminals connected under each VPN terminal 20. FIG. 19 shows an example of a schematic configuration of a VPN system according to this approach. With reference to FIG. 19, each VPN terminal 20 is connected to a plurality of lower-level terminals 70. When a lower-level terminal 70 connected to the own terminal is to transmit data to a lower-level terminal 70 connected to another VPN terminal 20, the own VPN terminal 20 adds, to the transmission data packet, header information described in a second communication protocol different from a first communication protocol that describes the original packet, so as to encapsulate into the form of a data packet described in the second communication protocol. Then, the own VPN terminal 20 transmits the transmission data packet. The another VPN terminal 20 having received the encapsulated data packet decapsulates the packet by removing the header information described in the second communication protocol and thereby restoring the packet into the form of a data packet described in the first communication protocol. Then, the another VPN terminal 20 transfers the data packet to the lower-level terminal 70 of the own. In the example shown in FIG. 19, each VPN terminal 20 serves as a router that mediates connection between a plurality of lower-level terminals 70 and the network 30. Also in the VPN system having the configuration in the example shown in FIG. 19, similarly to the VPN system having the configuration in the example shown in FIG. 1, when the terminal information registration processing (step S1 in FIG. 7; FIG. 8), the key registration processing (step S2 in FIG. 7; FIG. 9) and the key acquisition processing (step S3 in FIG. 7; FIG. 10) are performed, exchange of common keys to be used in encrypted communication between individual VPN terminals 20 is achieved.

Here, in the examples of processing of various kinds of exemplary embodiments described above, each VPN terminal 20 generates transmission keys to be used in encryption of information transmitted from the own apparatus to other VPN terminals 20 and then registers the transmission keys into the VPN-DNS server 10. Then, each VPN terminal 20 acquires from the VPN-DNS server 10 the transmission keys assigned to the own apparatus by other VPN terminals 20, as receiving keys to be used in decryption of encrypted information transmitted from other VPN terminals 20 to the own apparatus. Here, in another example of processing, in the examples of processing of various kinds of exemplary embodiments described above, each VPN terminal 20 may generate receiving keys to be used in decryption of encrypted information received by the own apparatus from other VPN terminals 20 and then register the receiving keys into the VPN-DNS server 10. Then, each VPN terminal 20 may acquire from the VPN-DNS server 10 the receiving keys assigned to the own apparatus by other VPN terminals 20, as transmission keys to be used in encryption of information to be transmitted from the own apparatus to other VPN terminals 20. In yet another example, a common key to be used between individual VPN terminals 20 may be generated from the transmission key and the receiving key exchanged between the individual VPN terminals 20 as a result of the processing of various kinds of exemplary embodiments described above. Then, encryption of transmission information and decryption of received information may be performed by using the generated common key.

The VPN terminal 20 described above is implemented typically by causing a general-purpose computer to execute a program that describes the function or the processing contents of each unit of the VPN terminal 20 described above. For example, as shown in FIG. 18, the computer has a hardware circuit configuration in which a CPU (central processing unit) 80, a memory (primary storage) 82, various I/O (input and output) interfaces 84, and the likes are connected via a bus 86. Further, an HDD (hard disk drive) 88 and a disk drive 90 for reading a portable nonvolatile recording medium as such a CD, a DVD, and a flash memory according to various kinds of standards are connected to the bus 86 via the I/O interfaces 84. The drive 88 or 90 serves as an external storage in comparison with the memory. A program that describes the processing contents according to the exemplary embodiment is saved into a fixed memory such as the HDD 88 via a recording media such as a CD and a DVD or via a network, and then installed into the computer. When the program stored in the fixed memory is read onto the memory and then executed by the CPU, the processing according to the exemplary embodiment is implemented. This approach is applicable also to the VPN-DNS server 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus connected to a management apparatus via a communication line, comprising:
an other-apparatuses information acquisition unit that acquires information concerning a plurality of other information processing apparatuses connected to a management apparatus, from the management apparatus connected via the communication line;
a key registration unit that registers first keys to be used in encrypted communication between the information processing apparatus and each of the plurality of other information processing apparatuses, into a storage unit, wherein each of the first keys is associated with a respective one of the plurality of other information processing apparatuses;
a key transmitting unit that collectively transmits the first keys to the management apparatus; and
a key acquisition unit that acquires from the management apparatus second keys that each corresponds to the information processing apparatus and that each has been transmitted to the management apparatus, from the respective one of plurality of other information processing apparatuses, wherein
the key registration unit further registers the second keys acquired by the key acquisition unit into the storage unit, and
each of the second keys is associated with the respective one of the plurality of other information processing apparatuses.

2. The information processing apparatus according to claim 1, wherein
the key registration unit includes an transmission key registration unit that registers in the storage unit the first keys as transmission keys for encrypting information which the information processing apparatus transmits to the plurality of other information processing apparatuses,
the key transmission unit collectively transmits the transmission keys to the management apparatus,
the key acquisition unit acquires the second key from the management,
each of the second keys is a transmission key which the respective one of the plurality of other information processing apparatuses has transmitted to the management apparatus, and
the key registration unit includes a receiving-key registration unit that registers in the storage unit the second keys as receiving keys for decrypting information which the information processing apparatus receives from the plurality of other information processing apparatus.

3. The information processing apparatus according to claim 1, wherein
the key registration unit includes an receiving-key registration unit that registers in the storage unit the first keys as receiving keys for decrypting information which the information processing apparatus receives from the plurality of other information processing apparatuses,
the key transmission unit collectively transmits the receiving keys to the management apparatus,
the key acquisition unit acquires the second key from the management,
each of the second keys is a receiving key which the respective one of the plurality of other information processing apparatuses has transmitted to the management apparatus, and
the key registration unit includes a transmission key registration unit that registers in the storage unit the second keys as transmission keys for encrypting information which the information processing apparatus transmits the plurality of other information processing apparatuses.

4. The information processing apparatus according to claim 2, further comprising:
an encrypted information transmitting unit that transmits encrypted information encrypted by the transmission key to one of the plurality of other information processing apparatus,
wherein the transmission key is stored in the storage unit and associated with said one of the plurality of other information processing apparatus.

5. The information processing apparatus according to claim 2, further comprising:
a decryption unit that decrypts information received from one of the plurality of other information processing apparatus by using the decryption key,
wherein the decryption key is stored in the storage unit and associated with said one of the plurality of other information processing apparatus.

6. The information processing apparatus according to claim 3, further comprising:
an encrypted information transmitting unit that transmits encrypted information encrypted by the transmission key to one of the plurality of other information processing apparatus,
wherein the transmission key is stored in the storage unit and associated with said one of the plurality of other information processing apparatus.

7. The information processing apparatus according to claim 3, further comprising:
a decryption unit that decrypts information received from one of the plurality of other information processing apparatus by using the decryption key,
wherein the decryption key is stored in the storage unit and associated with said one of the plurality of other information processing apparatus.

8. The information processing apparatus according to claim 1, further comprising:
an own-terminal information transmitting unit that transmits information concerning the information processing apparatus to the management apparatus.

9. The information processing apparatus according to claim 8,
wherein the own-terminal information transmitting unit that transmits, when the information concerning the information processing apparatus changes, the changed information to the management apparatus.

10. A management apparatus connected to an information processing apparatus and a plurality of information processing apparatuses other than the information processing apparatus via a communication line comprising:
an apparatus information transmission unit that transmits, to the information processing apparatus, information concerning the plurality of other information processing apparatuses;
a key acquisition unit that acquires from the information processing apparatus a key to be used in encrypted communication between the information processing apparatus and each of the plurality of other information processing apparatuses; and
a key transmitting unit that transmits to the information processing apparatus the key to be used in encrypted communication between the information processing apparatus and each of the plurality of other information processing apparatuses.

11. The management apparatus according to claim 10, further comprising:
an apparatus information registration unit that registers in a storage unit information concerning the information processing apparatus received from the information processing apparatus,
wherein the information concerning the plurality of other information processing apparatus is information acquired from the storage unit.

12. The management apparatus according to claim 10,
wherein the apparatus information transmission unit that transmits, when the information concerning the information processing apparatus changes, the changed information to the plurality of other information processing apparatuses.

13. A communication system comprising:
a management apparatus; and
an information processing apparatus connected to a management apparatus via a communication line,
wherein
the management apparatus connected to the information processing apparatus and a plurality of information processing apparatuses other than the information processing apparatus via the communication line,
wherein
the information processing apparatuses comprises:
an other-apparatuses information acquisition unit that acquires information concerning the plurality of other information processing apparatuses connected to a management apparatus, from the management apparatus connected via the communication line;
a key registration unit that registers first keys to be used in encrypted communication between the information processing apparatus and each of the plurality of other information processing apparatuses, into a storage unit, wherein each of the first keys is associated with a respective one of the plurality of other information processing apparatuses;
a key transmitting unit that collectively transmits the first keys to the management apparatus; and
a key acquisition unit that acquires from the management apparatus second keys that each corresponds to the information processing apparatus and that each has been transmitted to the management apparatus, from the respective one of plurality of other information processing apparatuses,
wherein
the key registration unit further registers the second keys acquired by the key acquisition unit into the storage unit, and
each of the second keys is associated with the respective one of the plurality of other information processing apparatuses, and
wherein
the management apparatus comprises:
an apparatus information transmission unit that transmits, to the information processing apparatus, information concerning the plurality of other information processing apparatuses;
a key acquisition unit that acquires from the information processing apparatus a key to be used in encrypted communication between the information processing apparatus and each of the plurality of other information processing apparatuses; and
a key transmitting unit that transmits to the information processing apparatus the key to be used in encrypted communication between the information processing apparatus and each of the plurality of other information processing apparatuses.

14. A computer readable medium storing a program causing a computer to execute a process for communications between a information processing apparatus and a plurality of other information processing apparatuses via a communication line, the process comprising:
acquiring information concerning the plurality of other information processing apparatuses connected to a management apparatus, from the management apparatus connected via communication line;
storing first keys to be used in encrypted communication between the information processing apparatus and each of the plurality of other information processing apparatuses, into a storage, wherein each of the first keys is associated with a respective one of the plurality of other information processing apparatuses;
transmitting collectively the first keys to the management apparatus;
acquiring from the management apparatus second keys that each corresponds to the information processing apparatus and that each has been transmitted from the respective one of plurality of other information processing apparatuses to the management apparatus; and
storing the second keys acquired by the key acquisition unit,
wherein each of second keys is associated with the respective one of the plurality of other information processing apparatuses.

15. A computer readable medium storing a program causing a computer to execute a process for communications between a information processing apparatus and a plurality of other information processing apparatuses via a communication line, the process comprising:
transmitting, to the information processing apparatus, information concerning the plurality of other information processing apparatus;
acquiring from the information processing apparatus a key to be used in encrypted communication between the information processing apparatus and each of the plurality of other information processing apparatuses; and
transmitting to the information processing apparatus the key to be used in encrypted communication between the information processing apparatus and each of the plurality of other information processing apparatuses.
